(19) United States
(12) Patent Application Publication
(10) Pub. No.: US 2018/0046264 A1
(43) Pub. Date: Feb. 15, 2018

(54) METHOD FOR TRANSMITTING A VIRTUAL OBJECT BETWEEN ELECTRONIC DEVICES

(71) Applicant: National Taiwan Normal University, Taipei City (TW)

(72) Inventors: Jon-Chao HONG, Taipei City (TW); Kai-Hsiang YANG, Taipei City (TW); Ming-Yueh HWANG, Taipei City (TW); Kai-Hsin TAI, Taipei City (TW); Chi-Ruei TSAI, Taipei City (TW)

(73) Assignee: National Taiwan Normal University, Taipei City (TW)

(21) Appl. No.: 15/452,496

(22) Filed: Mar. 7, 2017

(30) Foreign Application Priority Data
Aug. 11, 2016 (TW) 105125553

(51) Int. Cl. G06F 3/0346; G06F 3/0481; G06F 3/14

(52) U.S. Cl. CPC G06F 3/0346; G06F 3/1454; G06F 3/0481

(57) ABSTRACT

A method for transmitting a virtual object from a first electronic device to a second electronic device includes steps of: controlling the first electronic device to display a virtual object; in response to receipt of a request from the second electronic device, allowing user input of a user command to the first electronic device; and after the user command is detected, transmitting, by the first electronic device, object data associated with the virtual object to the second electronic device, so as to enable the second electronic device to display the virtual object based on the object data.

### CROSS-REFERENCE TO RELATED APPLICATION

This application claims priority of Taiwanese Patent Application No. 105125553, filed on Aug. 11, 2016.

### FIELD

The disclosure relates to a method for transmitting a virtual object between electronic devices.

### BACKGROUND

A conventional portable device (e.g., a smartphone, a tablet, etc.) may be programmed to execute applications, to communicate with other electronic devices, and/or to display one or more virtual objects in response to execution of certain applications.

### SUMMARY

One object of the disclosure is to provide a method that facilitates transmission of a virtual object from a first electronic device to a second electronic device.

According to one embodiment of the disclosure, the method is implemented by the first electronic device that includes a processor, a display, an input module and a communication module, the method includes steps of:

controlling, by the processor, the display to display a virtual object;

in response to receipt of a request from the second electronic device, controlling, by the processor, the input module to allow user input of a user command;

detecting, by the processor, the user command from the input module; and

after the user command is detected, controlling, by the processor, the communication module to transmit object data associated with the virtual object to the second electronic device, so as to enable the second electronic device to display the virtual object based on the object data.

According to another embodiment of the disclosure, the method for transmitting a virtual object between a first electronic device and a second electronic device in an electronic system is implemented by the electronic system. The method includes steps of:
controlling, by a processor of the first electronic device, a display of the first electronic device to display a virtual object;
controlling, by a processor of the second electronic device, a communication module of the second electronic device to send a request for the virtual object to the first electronic device;
in response to receipt of the request from the second electronic device, controlling, by the processor of the first electronic device, an input module of the first electronic device to allow user input of a user command;
detecting, by the processor of the first electronic device, the user command from the input module of the first electronic device;
after the user command is detected, controlling, by the processor of the first electronic device, a communication module of the first electronic device to transmit object data associated with the virtual object to the second electronic device; and
controlling, by a processor of the second electronic device, a display of the second electronic device to display the virtual object based on the object data.

Another object of the disclosure is to provide an electronic system that is capable of implementing the above-mentioned method.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating an electronic system according to one embodiment of the disclosure;

FIG. 2 is a flowchart illustrating steps of a method for transmitting a virtual object between electronic devices of an electronic system, according to one embodiment of the disclosure;

FIG. 3 illustrates transmission of a request from a second electronic device to a first electronic device;

FIG. 4 illustrates virtual transmission of the virtual object from the first electronic device to the second electronic device;

FIGS. 5A and 5B cooperatively form a flow chart illustrating steps of a method for transmitting a virtual object between electronic devices of an electronic system, according to another embodiment of the disclosure; and

FIGS. 6 and 7 illustrate virtual transmission of one of a plurality of virtual objects from the first electronic device to the second electronic device.

### DETAILED DESCRIPTION

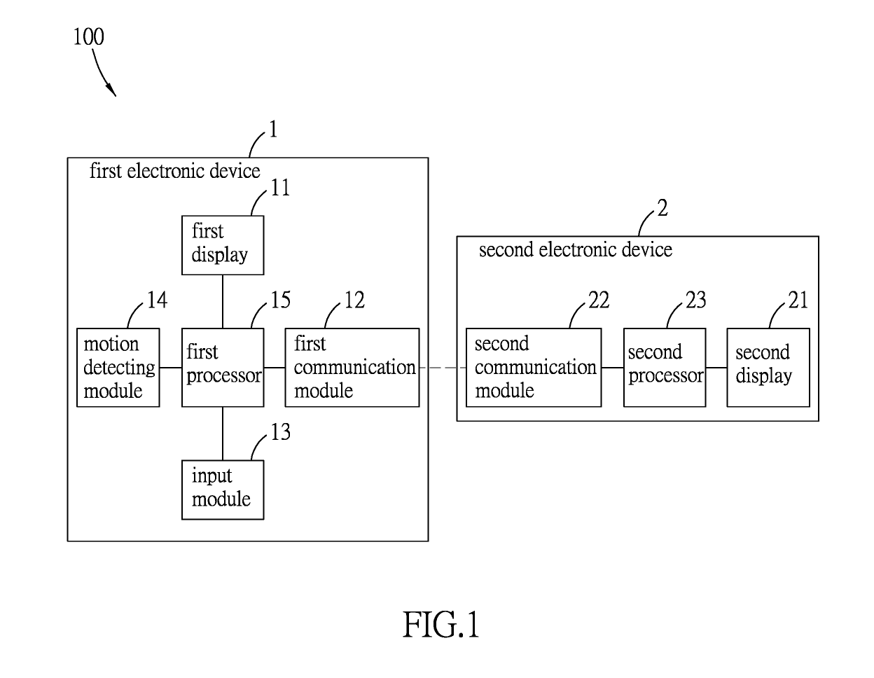

FIG. 1 is a block diagram illustrating an electronic system 100 according to one embodiment of the disclosure. The electronic system 100 includes a first electronic device 1 and a second electronic device 2.

The first electronic device 1 may be embodied using a tablet or a smartphone, and includes a first display 11, a first communication module 12, an input module 13, a motion detecting module 14, and a first processor 15.

The first display 11 may be embodied using a liquid crystal display (LCD) screen. The first communication module 12 may include components that support wireless transmission such as Bluetooth®, near field communication (NFC), the third generation of wireless mobile telecommunications technology (3G), the fourth generation of wireless mobile telecommunication technology (4G), etc.

The input module 13 may be embodied using a touch screen and/or a set of buttons. In this embodiment, the first display 11 and the input module 13 are integrated as a touch screen. The motion detecting module 14 includes, for example, an accelerometer and a gyroscope for detecting movement of the first electronic device 1. The first processor 15 is electrically connected to the first display 11, the first communication module 12, the input module 13 and the motion detecting module 14, and is capable of executing an application and subsequently causing the first display 11 to display information, such as a virtual object.

The second electronic device 2 maybe embodied using a tablet or a smartphone, and includes at least a second display 21, a second communication module 22 and a second processor 25.

The second display 21 may be embodied using an LCD screen. The second communication module 12 may include components that support wireless transmission such as Bluetooth®, NFC, 3G, 4G, etc. The second communication module 12 is capable of establishing a communication with the first communication module 22 using one of the technologies supported.

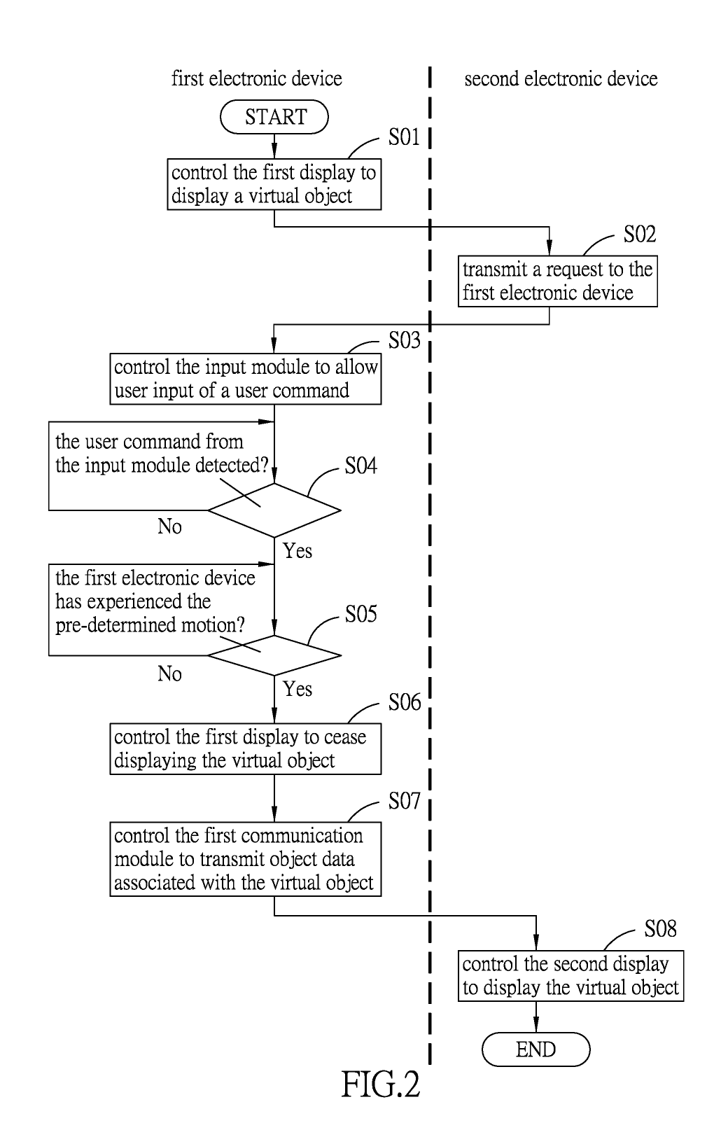

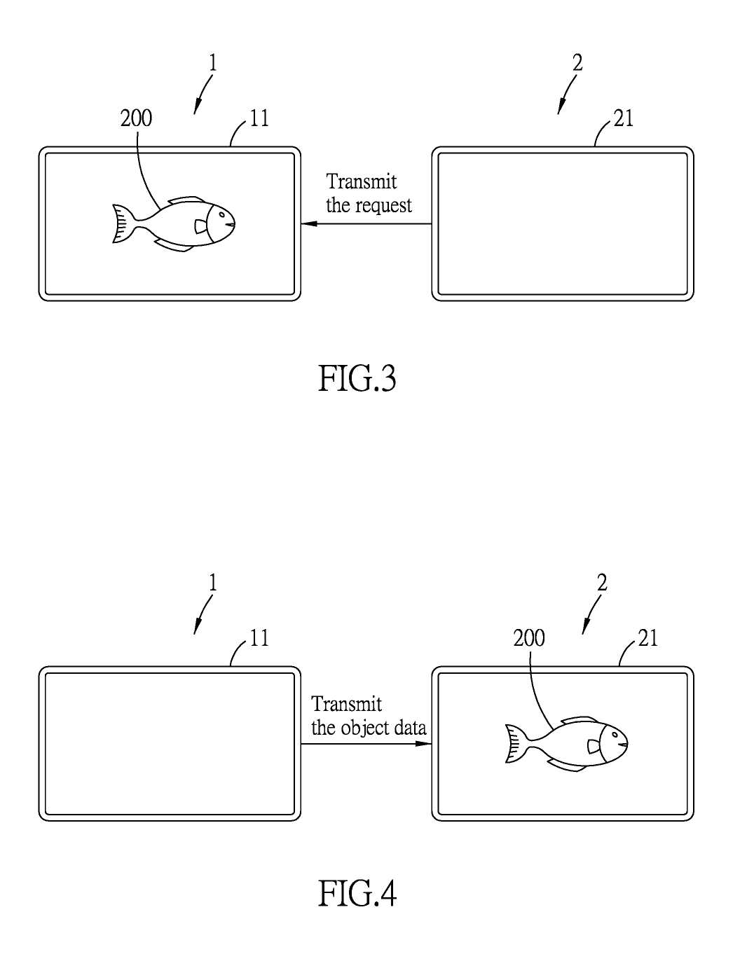

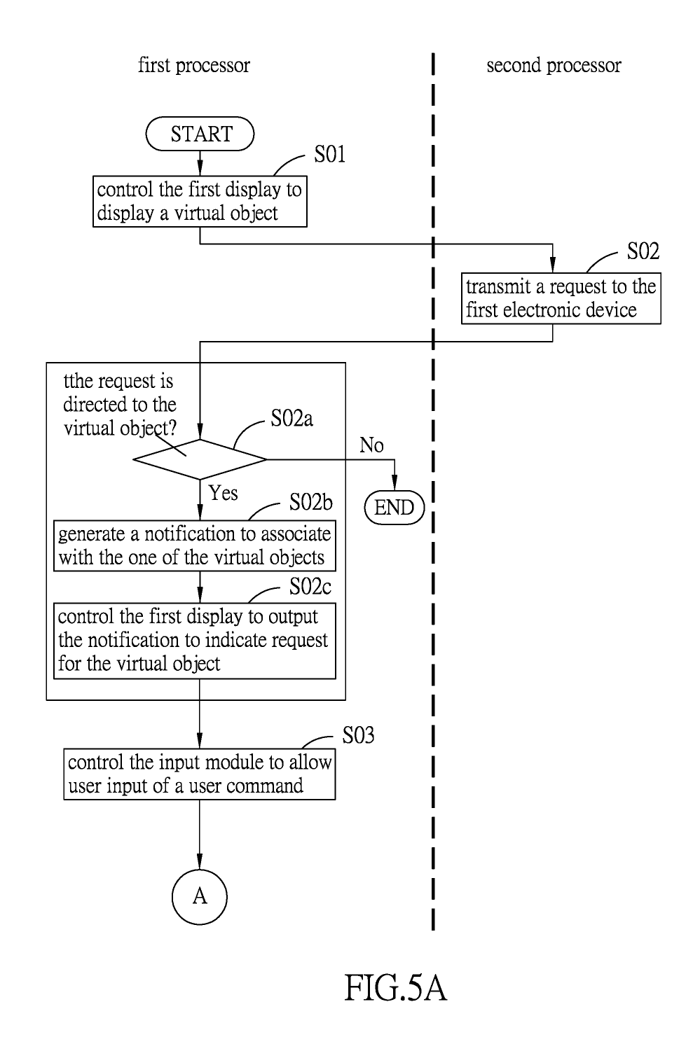

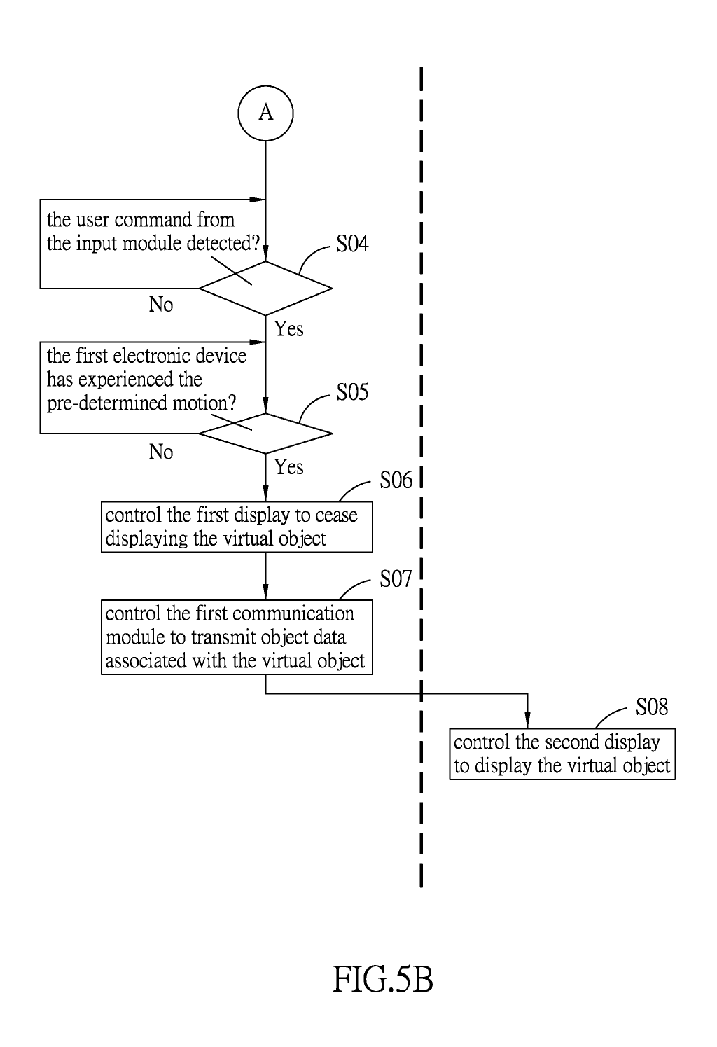

Further referring to FIGS. 2-4, a flowchart illustrating steps of a method for transmitting a virtual object between electronic devices is shown in FIGS. 5A and 5B, according to one embodiment of the disclosure.

In step S01, the first processor 15 of the first electronic device 1, when executing the application, controls the first display 11 to display a virtual object 200 thereon. In this embodiment, the first display 11 is controlled to display a moving fish. In other embodiments, the virtual object 200 maybe a badge, a playing card, a pet, etc.

In step S02, the second processor 25 of the second electronic device 2 transmits a request to the first electronic device 1 via the second communication module 22. The request may indicate that a user of the second electronic device 2 intends to obtain a virtual object.

In step S03, in response to receipt of the request from the second electronic device 2, the first processor 15 controls the input module 13 to allow user input of a user command. The user command may indicate that a user of the first electronic device 1 agrees to transmit a virtual object currently displayed by the first display 11 (e.g., the virtual object 200 of the moving fish) to the second electronic device 2. In this embodiment, the user of the first electronic device 1 may be instructed to select the virtual object 200 by touching the virtual object 200 directly on the first display 11, or to touch a confirm box displayed on the first display 11.

Further referring to FIG. 5B, in step S04, the first processor 15 detects the user command from the input module 13. That is to say, unless the first processor 15 receives the user command indicating that the user of the first electronic device 1 agrees to transmit the virtual object 200 (by transmitting the user command), the first processor 15 does not proceed to perform the subsequent steps.

When the user command is detected, the flow proceeds to step S05. Otherwise, the first electronic device 1 continues to detect the user command. In some embodiments, the first electronic device 1 continues to detect the user command for a first time period (e.g., 10 seconds), and terminates the method when the first time period has elapsed.

After the user command is detected, in step 505, the processor 15 is programmed to determine, based on readings from the motion detecting module 14, whether the first electronic device 1 has experienced a pre-determined motion. In this embodiment, the first processor 15 is programmed to determine whether the first electronic device 1 has experienced the pre-determined motion by determining whether the first electronic device 1 has been shaken for a predetermined number of times (e.g., 2n times) within a predetermined duration (e.g., 10 seconds).

When it is determined that the first electronic device 1 has experienced the pre-determined motion, the flow proceeds to step S06. Otherwise, the first electronic device 1 continues to detect the pre-determined motion. In some embodiments, the first electronic device 1 continues to detect the pre-determined motion for a second time period (e.g., 10 seconds), and terminates the method when the second time period has elapsed.

In step S06, the first processor 15, after it is determined that the first electronic device 1 has experienced the pre-determined motion, controls the first display 1 to cease displaying the virtual object 200, signifying virtual transmission of the virtual object 200 to the second electronic device 2.

In step S07, the first processor 15 controls the first communication module 12 to transmit object data associated with the virtual object 200 to the second electronic device 2.

In response to the object data, in step S08, the second processor 25 of the second electronic device 2 controls the second display 21 to display the virtual object 200 based on the object data.

Referring to FIGS. 1, 3, 4, 5A and 5B, according to another embodiment of the disclosure, in transmitting the request, the user of the second electronic device 2 maybe able to specifically request a specific virtual object. Accordingly, the request transmitted by the second electronic device 2 may be directed to the virtual object 200 of the moving fish currently displayed on the first display 11.

In such a case, in response to the request, the first processor 15 further performs the following steps S02a-S02c before step S03.

In step S02a, the first processor 15 determines whether the request is directed to the virtual object 200. When it is determined that the request is directed to said virtual object 200, the first processor 15 generates a notification associated with the virtual object 200 in sub-step S02b. Otherwise, the method may be terminated. Then, in sub-step S02c, the first processor 15 controls the first display 11 to output the notification to indicate request for the virtual object 200.

In this embodiment, the first processor 15 is programmed to control the first display 11 to output the notification by shaking the virtual object 200 to visually notify the user of the first electronic device 1 of the request from the second electronic device 2. In another embodiment, the first processor 15 is programmed to control the input module 13 to allow user input of a user command to agree to transmit the virtual object 200 to the second electronic device 2.

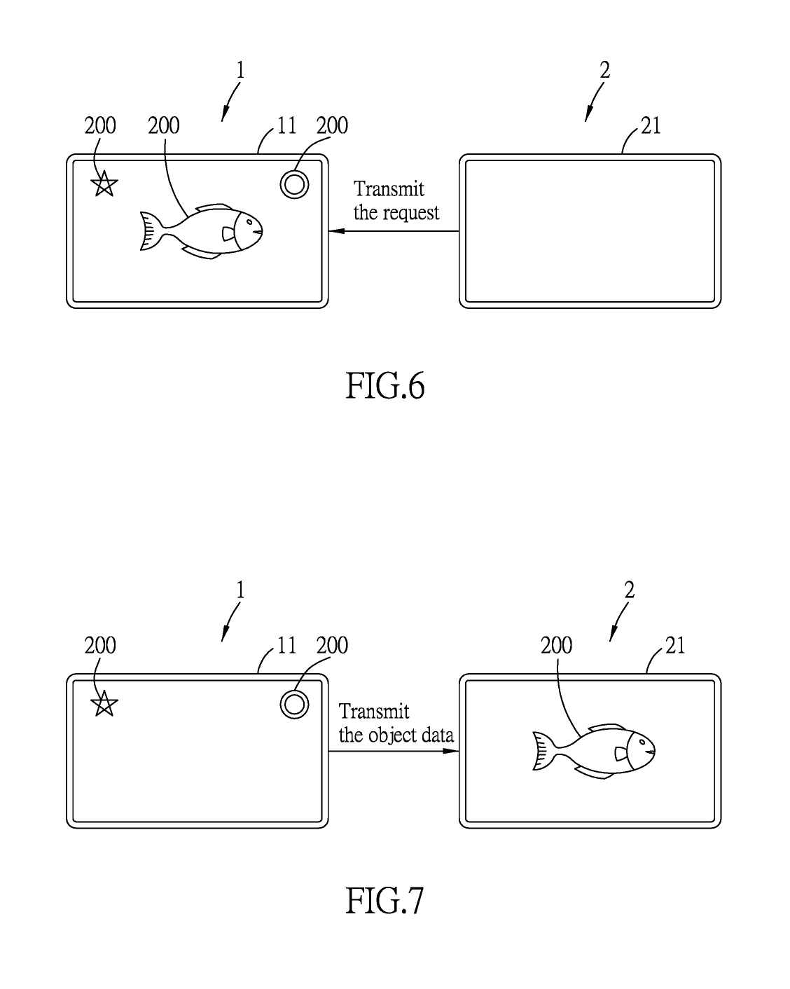

Referring to FIGS. 5A, 5B, 6 and 7, in one embodiment of the disclosure, in step S01, the processor 15 may control the first display 11 to display a plurality of virtual objects 200 thereon.

Also, for the user of the second electronic device 2, it is possible to designate the request to one of the plurality of virtual objects 200.

Accordingly, in sub-step S02a of the method of FIG. 5A, the first processor 15 determines one of the virtual objects 200 to which the request is directed.

In sub-step S02b, the first processor 15 generates a notification to associate with the one of the virtual objects 200. Then, in sub-step S02c, the first processor 15 controls the first display 11 to output the notification to indicate request for the one of the virtual objects 200, for example, by shaking the one of the virtual objects 200.

Referring to FIGS. 2, 6 and 7, in one embodiment of the disclosure, in step S01, the processor 15 may control the first display 11 to display a plurality of virtual objects 200 thereon. In this case, the user of the first electronic device 1 may be able to select one of the virtual objects 200 to be transmitted to the second electronic device 2.

Accordingly, after receipt of the request, in step S03 of the method of FIG. 2, the first processor 15 controls the input module 13 to allow user input of a user command to select one of the virtual objects 200. Afterward, in step S04, the first processor 15 determines a selected one of the virtual objects 200 according to the user command, and controls the first communication module 12 to transmit object data associated with the selected one of the virtual objects 200 to the second electronic device 2.

To sum up, embodiments of the disclosure provide a method for facilitating the virtual object 200 to be transmitted between the first and second electronic devices 1, 2. In the method, after the object data is transmitted, the first electronic device 1 may be controlled to cease displaying the virtual object 200, so as to produce the effect of the transmission of the virtual object 200 from the first electronic device 1 to the second electronic device 2. Further, the virtual object 200 is transmitted only after the first electronic device 1 has experienced the pre-determined motion, thereby making the method more interactive with the user.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for transmitting a virtual object from a first electronic device to a second electronic device, the method being implemented by the first electronic device that includes a processor, a display, an input module and a communication module, the method comprising steps of:
a) controlling, by the processor, the display to display a virtual object;
b) in response to receipt of a request from the second electronic device, controlling, by the processor, the input module to allow user input of a user command;
c) detecting, by the processor, the user command from the input module; and
d) after the user command is detected, controlling, by the processor, the communication module to transmit object data associated with the virtual object to the second electronic device, so as to enable the second electronic device to display the virtual object based on the object data.

2. The method of claim 1, further comprising a step of:
after the user command is detected, controlling, by the processor, the display to cease displaying the virtual object.

3. The method of claim 1, the first electronic device further including a motion detecting module, wherein step d) includes sub-steps of:
determining, based on readings from the motion detecting module, whether the first electronic device has experienced a pre-determined motion; and
controlling the communication module to transmit the object data when it is determined that the first electronic device has experienced the pre-determined motion.

4. The method of claim 3, wherein the processor is programmed to determine whether the first electronic device has experienced the pre-determined motion by determining whether the first electronic device has been shaken for a predetermined number of times within a predetermined duration.

5. The method of claim 1, further comprising, before step b), steps of:
determining, by the processor, whether the request is directed to the virtual object;
generating, by the processor, a notification associated with the virtual object when it is determined that the request is directed to the virtual object; and
controlling, by the processor, the display to output the notification to indicate the virtual object.

6. The method of claim 5, wherein the processor is programmed to control the display to output the notification by shaking the virtual object.

7. The method of claim 5, wherein in step b), the processor is programmed to control the input module to allow the user input of the user command to agree to transmit the virtual object to the second electronic device.

8. The method of claim 1, wherein in step a), the processor controls the display to display a plurality of virtual objects, and the method further comprises, before step b), steps of:
determining, by the processor, one of the virtual objects to which the request is directed;
generating, by the processor, a notification to associate with the one of the virtual objects; and
controlling, by the processor, the display to output the notification to indicate the one of the virtual objects.

9. The method of claim 8, wherein the processor is programmed to control the display to output the notification by shaking the one of the virtual objects to which the request is directed.

10. The method of claim 8, wherein step b) includes controlling the input module to allow user input of a user command to agree to transmit the one of the virtual objects to the second electronic device.

11. The method of claim 1, wherein:
in step a), the processor controls the display to display a plurality of virtual objects;
in step b), the processor controls the input module to allow user input of a user command to select one of the virtual objects;
in step d), the processor determines a selected one of the virtual objects according to the user command, and controls the communication module to transmit object data associated with the selected one of the virtual objects to the second electronic device.

12. A method for transmitting a virtual object between a first electronic device and a second electronic device in an electronic system, the method being implemented by the electronic system and comprising steps of:
controlling, by a processor of the first electronic device, a display of the first electronic device to display a virtual object;
controlling, by a processor of the second electronic device, a communication module of the second electronic device to send a request for the virtual object to the first electronic device;
in response to receipt of the request from the second electronic device, controlling, by the processor of the first electronic device, an input module of the first electronic device to allow user input of a user command;
detecting, by the processor of the first electronic device, the user command from the input module of the first electronic device;
after the user command is detected, controlling, by the processor of the first electronic device, a communication module of the first electronic device to transmit object data associated with the virtual object to the second electronic device; and
controlling, by the processor of the second electronic device, a display of the second electronic device to display the virtual object based on the object data.

13. An electronic system comprising:
a first electronic device including a first display, an input module, a first communication module, and a first processor electrically connected to said first display, said input module and said first communication module; and
a second electronic device including a second display, a second communication module, and a second processor electrically connected to said second display and said second communication module,
wherein said first processor is programmed to control said first display to display a virtual object, and said second processor is programmed to control said second communication module to send a request to said first electronic device;
wherein, in response to receipt of the request from said second electronic device, said first processor is programmed to control said input module to allow user input of a user command, to detect the user command from said input module, and to control said first communication module to transmit object data associated with the virtual object to said second electronic device after the user command is detected;
wherein, in response to receipt of the object data from said first electronic device, said second processor is programmed to control said second display to display the virtual object based on the object data.

14. The electronic system of claim 13, wherein, in response to receipt of the request from said second electronic device, said first processor is further programmed to control said first display to cease displaying the virtual object.

15. The electronic system of claim 13, wherein said first electronic device further includes a motion detecting module for detecting movement of said first electronic device, and
wherein, in response to receipt of the request from said second electronic device, said first processor is further programmed to determine, based on readings from said motion detecting module, whether said first electronic device has experienced a pre-determined motion, and to control said first communication module to transmit the object data when it is determined that said first electronic device has experienced the pre-determined motion.

16. The electronic system of claim 15, wherein said first processor is programmed to determine whether said first electronic device has experienced the pre-determined motion by determining whether said first electronic device has been shaken for a predetermined number of times within a predetermined duration.

17. The electronic system of claim 13, wherein, in response to receipt of the request from said second electronic device, said first processor is programmed to:
determine whether the request is directed to the virtual object;
generate a notification associated with the virtual object when it is determined that the request is directed to the virtual object; and
control said first display to output the notification to indicate the virtual object.

18. The electronic system of claim 17, wherein said first processor is programmed to control said first display to output the notification by shaking the virtual object.

19. The electronic system of claim 17, wherein, in response to receipt of the request from said second electronic device, said first processor is programmed to control said input module to allow the user input of the user command to agree to transmit the virtual object to said second electronic device.
